(19) United States
(12) Patent Application Publication
(10) Pub. No.: US 2026/0245367 A1
(43) Pub. Date: Aug. 20, 2026

(54) VEHICLE IDENTIFICATION USING IMAGE EMBEDDINGS AND METADATA ANALYSIS

(71) Applicant: Metropolis IP Holdings, LLC, Santa Monica, CA (US)

(72) Inventors: Ji Sung Hwang, Albany, CA (US); Anil Kumar Nayak, Los Angeles, CA (US); Kushal Bhagwan Kusram, Los Angeles, CA (US); Saksham Jindal, Seattle, WA (US); Barry James O'Brien, Seattle, WA (US)

(21) Appl. No.: 19/054,528

(22) Filed: Feb. 14, 2025

(51) Int. Cl. G06V 20/52; G06F 16/532; G06F 16/583; G06T 7/70

(52) U.S. Cl. CPC G06V 20/52; G06F 16/532; G06F 16/583; G06T 7/70; G06V 2201/08

(57) ABSTRACT

A system or method for managing and tracking vehicle movements within a managed facility. The system receives an image of a vehicle captured by a camera within a managed facility and generates an embedding representing the vehicle using a trained machine learning model. A first similarity analysis is performed to compare the embedding against a database of embeddings generated from previously captured vehicle images, resulting in a set of candidate matches. The system also generates metadata of the vehicle based on the image of the vehicle. A second similarity analysis evaluates the generated metadata against the metadata of the candidate matches to identify a most similar vehicle within the set. An identifier of the most similar vehicle is determined as an identifier of the input vehicle.

### TECHNICAL FIELD

The disclosure generally relates to machine learning and computer vision, and more particularly relates to using advance machine learning and computer vision techniques for sophisticated vehicle identification in managed facilities.

### BACKGROUND

Traditional vehicle identification systems often rely on license plate recognition to identify vehicles. Such systems face significant challenges in environments where license plates are obscured, misread, or not fully visible. Dirt, damage, or poor lighting conditions can hinder the ability of license plate recognition systems to extract accurate text from license plates. Even when visible, slight variations in the captured image may result in misreads. These limitations can lead to operational inefficiencies, as vehicles cannot be reliably matched or identified, particularly in scenarios requiring high accuracy, such a sparking systems, toll booths, car wash, or security checkpoints.

Moreover, existing vehicle identification systems often lack sufficient vehicle context to differentiate between visually similar vehicles. For example, multiple white sedans of the same make and model, such as identical TESLA® vehicles at EV charging stations, can confound systems relying on images. Further, the scalability of image searches also presents a substantial challenge. In cases where license plate recognition systems fail, searching for a match among millions or billions of stored vehicle images can be computationally intensive and time-consuming. Traditional systems often struggle with these large datasets, leading to delays or reduced accuracy.

This issue becomes even more pronounced in high-traffic environment or when attempting to track unregistered vehicles, such as flagged or violator vehicles in enforcement applications.

### SUMMARY

Embodiments described herein address the limitations of traditional vehicle identification systems by generating an embedding of a vehicle based on its visual features to perform a first analysis for vehicle identification and incorporating metadata into a secondary analysis to enhance identification precision. As such, the embodiments allow a vehicle identification system (herein after also referred to as “the system”) to match vehicles even when traditional identifiers, such as license plates, are obscured, unreadable, or missing, or when ambiguities are present for vehicles that look similar.

In some embodiments, the system receives an image of a vehicle captured by a camera in a managed facility and generates an embedding representative of the vehicle based on the received image using a trained machine learning model. The system performs a first similarity analysis of the embedding against a database of embeddings generated based on previously captured vehicle images to identify a set of candidate matches. Each candidate match in the set of candidate matches corresponds to an identifier of a vehicle. The system also generates metadata of the vehicle based on the image of the vehicle, and retrieves metadata associated with the candidate matches. The metadata may include (but is not limited to) vehicle make, model, color, and/or license plate layout. The system performs a second similarity analysis of metadata of the vehicle against the metadata of the set of candidate matches to identify a most similar vehicle in the set of candidate matches, and determines an identifier of the most similar vehicle in the set of candidate matches as an identifier of vehicle.

In some embodiments, the embedding representative of the vehicle is generated by applying a first machine-learning model to the image of the vehicle to identify a position of the vehicle in the image, generating a bounding box surrounding the vehicle in the image, and applying a second machine learning model to a portion of the image in the bounding box to generate the embedding of the vehicle.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates an example system environment for managing vehicle parking or transit through a managed facility, in accordance with one or more embodiments.

FIG. 2 illustrates an example architecture of an edge device, in accordance with one or more embodiments.

FIG. 3 illustrates an example architecture of the vehicle management server, in accordance with one or more embodiments.

FIG. 4 illustrates an example embedding space of vehicles, in accordance with one or more embodiments.

FIG. 5 is a flowchart of an example method for tracking vehicles in managed facilities, in accordance with one or more embodiments.

FIG. 6A-6C depict an exemplary managed facility and moveable gate in accordance with one or more embodiments.

FIG. 7 is a block diagram illustrating components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Traditional vehicle identification systems often primarily rely on license plate recognition to identify vehicles, but these systems face various challenges in real-world environments. For example, license plates that are obscured by dirt, damage, or poor lighting often become unreadable, hindering the ability of these systems to extract accurate text. Even when plates are visible, minor variations in captured images can result in misreads, further reducing reliability. These shortcomings lead to operational inefficiencies, especially in applications requiring high precision, such as parking systems, toll booths, or security checkpoints. Additionally, traditional systems lack the contextual awareness needed to differentiate between visually similar vehicles, such as identical white sedans of the same make and model at an EV charger. When license plate recognition fails, the scalability of image-based searches becomes a significant bottleneck. Searching vast datasets containing millions or billions of vehicle images is computationally expensive and time-consuming, often resulting in delays and decreased accuracy.

The embodiments described herein address the limitations of traditional vehicle identification systems by combining advanced machine learning and contextual analysis to enhance accuracy and efficiency. Instead of relying solely on license plate recognition, the system generates a robust embedding of each vehicle based on its visual features, such as shape, size, and unique markings. This embedding enables reliable identification even when license plates are obscured, unreadable, or missing. To further refine results, the system incorporates metadata, such as vehicle make, model, color, and license plate state, into a secondary analysis. This multi-layered approach allows the system to differentiate between visually similar vehicles, such as identical white sedans at an EV charger. Additionally, by clustering embeddings and leveraging optimized search techniques, the invention reduces computational overhead, enabling efficient identification within large-scale datasets containing millions of vehicle images. These embodiments ensure scalable, precise, and reliable vehicle identification, even in complex environments or scenarios requiring high accuracy.

### Configuration Overview

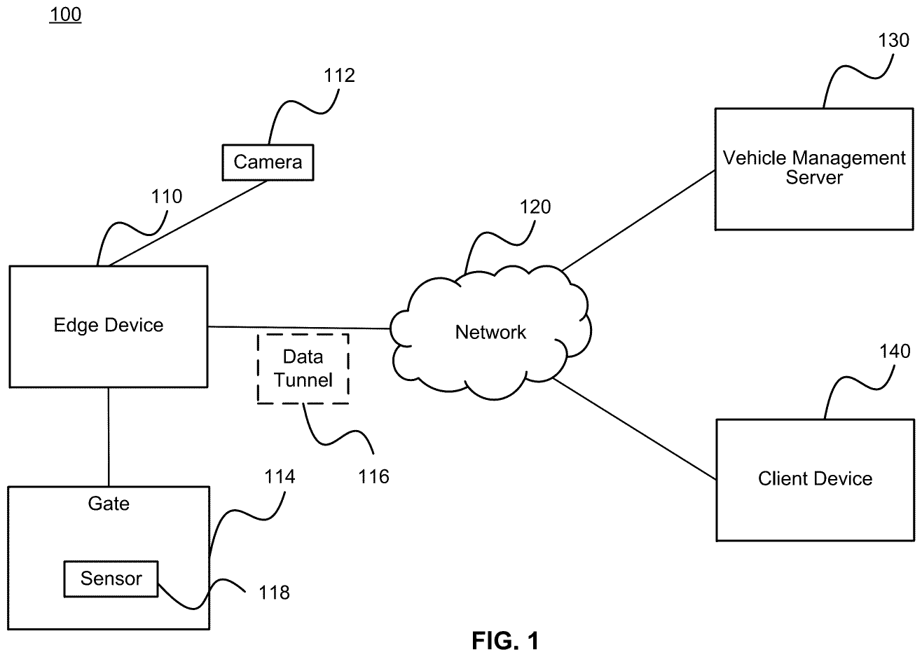

FIG. 1 illustrates an example system environment 100 for managing vehicle parking or transit through a managed facility, in accordance with one or more embodiments. A managed facility is referred to any environment or area where access may be monitored and/or regulated. These facilities may include parking garages, car wash, corporate campuses, hospitals, logistics and distribution centers, university campuses, gated communities, airports, shopping centers, among others.

The environment 100 includes one or more edge devices 110, one or more cameras 112, one or more gates 114, data tunnels 116, and sensors 118, one or more client devices 140, the vehicle management server 130, and a network 120. While only one of each feature of environment is depicted, this is for convenience only, and any number of each feature may be present. Where a singular article is used to address these features (e.g., “camera 112”), scenarios where multiples of those features are referenced are within the scope of what is disclosed (e.g., a reference to “camera 112” may mean that multiple cameras are involved). For example, a first camera 112 and a first edge device 110 may be located at an entry of the managed facility, a second camera 112 and a second edge device 110 may be locate at an exit of the managed facility, and additional cameras 112 and edge devices 110 may be located at intersections within the managed facility.

The network may include (but is not limited to) the internet, local area network (LAN), wireless local area network (WLAN), or cellular networks (such as 2G, 3G, 4G, 5G, 6G, among others), wireless personal area network (WPAN), enabling data exchange between the edge devices 110, the vehicle management server 130, and client devices 140.

Gates 114 are physical or logical barriers that control vehicle entry and exit at the managed facility. The cameras 112 are configured to capture images and videos of vehicles from various angles and locations in the managed facility. The sensors 118 work alongside the cameras to detect various conditions at the managed facility, such as vehicle presence, speed, direction, and/or infractions, among others.

Edge devices 110 may be coupled to cameras 112, sensors 118, and/or gates 114, and configured to receive and process images and sensing data generated by the cameras and/or sensors to detect events, such as vehicle entry, vehicle exit, vehicle approaching, leaving, vehicle speed, and/or infractions. In some embodiments, edge devices 110 are also configured to apply pre-trained machine-learning models to received images and sensing data to detect events, generate metadata, and identify vehicles.

Alternatively, metadata generation and vehicle identification may be performed by the vehicle management server 130. For example, edge devices 110 may send vehicle-related data to the vehicle management server 130 for further processing (e.g., metadata generation, vehicle identification) and receive the processed data (e.g., identifier of the vehicle) from the vehicle management server 130.

In some embodiments, edge devices 110 may be configured to generate preliminary embeddings, which are numerical representations of the vehicle's visual characteristics, using pre-trained machine learning models. These embeddings capture features like shape, texture, and unique markings that are useful for matching vehicles in a database. Object detection results, such as identifying multiple vehicles in the image, are also included in this metadata. These pre-processed outputs reduce computational loads on vehicle management server 130 and enable faster decision-making.

The metadata generated by the edge devices 110 may include (but is not limited to) vehicle-specific metadata, event-related metadata, anomaly detection metadata, camera or sensor-specific metadata, among others. Vehicle-specific metadata may be generated by analyzing captured images. Such metadata describes the physical characteristics of the vehicles. For instance, color detection models can determine whether a vehicle is predominantly red, blue, or gray, while vehicle detection models may classify a vehicle as a sedan, SUV, or truck.

Events are associated with vehicles'movement, time, and/or pose (which includes the vehicle's location and orientation). Event-related metadata may be generated by capturing temporal and spatial aspects of a vehicle's interactions with the managed facility. Such metadata may include timestamps and locations of detected events, and corresponding vehicle's speed and direction of movement. Timestamps record the exact time of entry or exit, while sensors detect the vehicle's speed and direction, such as whether it is entering, exiting, or reversing. Location metadata pinpoints the specific zone or area where the event occurred, such as at an entry gate or in a particular parking space.

In some embodiments, events may include anomalies or infractions. The edge devices 110 may be configured to detect anomalies in real-time and generate corresponding metadata. For example, when two vehicles pass through a gate closely without independent validation, the edge device identifies and logs a tailgating event. Similarly, infractions such as improper parking, unauthorized entry, or violations of facility rules are recorded as metadata.

Camera or sensor-specific metadata provides contextual information about the source of the captured images or sensing data. This may include (but is not limited to) the position and angle of the camera. Additionally, the edge devices 110 may analyze image quality parameters such as lighting conditions, resolution, or noise levels. This metadata may be useful for assessing the reliability of visual data.

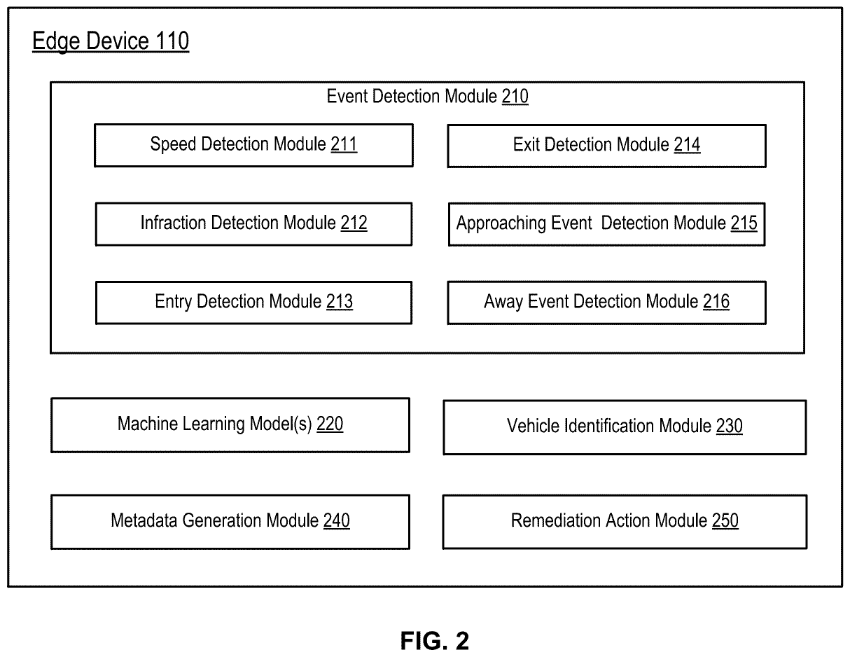

Additionally, in some embodiments, the edge devices 110 can make real-time decisions based on the output of the machine learning models or processed data received from the vehicle management server 130, such as determining whether an identified vehicle is authorized to enter the managed facility. In response to determining that the identified vehicle is authorized to enter the managed facility, edge devices cause a gate 114 to open. Additional details about edge devices 110 are further described below with respect to FIG. 2.

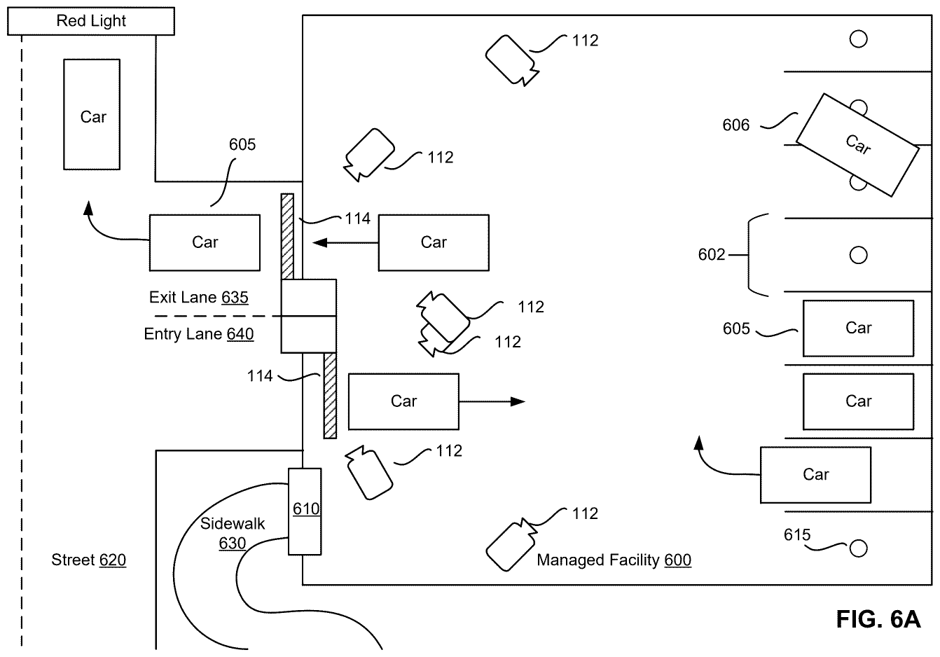

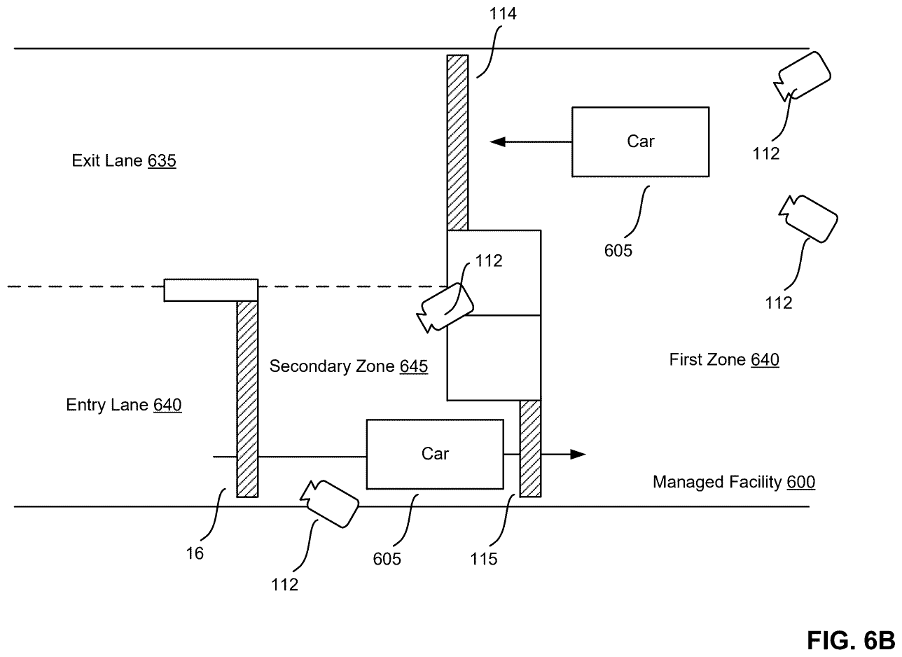

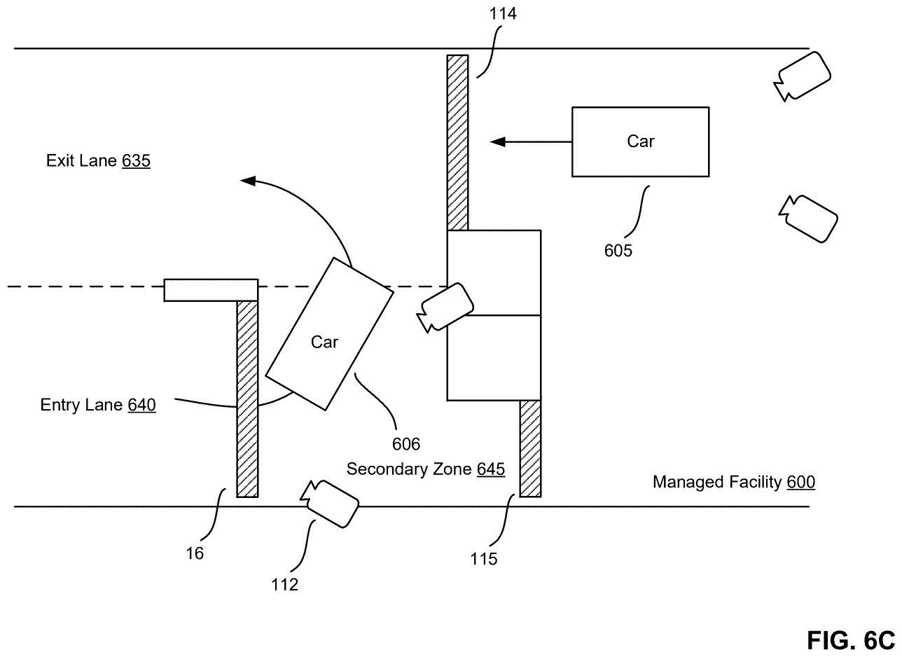

In a managed facility, edge devices 110, cameras 112, and/or sensors 118 are strategically positioned to maximize coverage and functionality. These devices are typically installed near key access points, such as vehicle entry and exit gates, junctions, boundaries between different zones, high traffic areas, loading docks, pedestrian entry points, among others. Cameras may be mounted in locations that offer wide, unobstructed view of these areas to capture clear images and videos of vehicles as they enter, exit, and navigate the facility. Additional details related to a managed facility are further described below with respect to FIGS. 6A-6C.

The vehicle management server 130 receives data from the edge devices 110, including vehicle images and sensing data. As described above, in some embodiments, the edge devices 110 may be configured to identify vehicles and events. These identified vehicles and events are transmitted to the vehicle management server 130 for storage or further processing. Alternatively, the vehicle management server 130 is configured to perform vehicle identification.

Further, the vehicle management server 130 is also better suited for perform more complex and larger scale processing, such as data storage, profile updates, session management, and possibly retraining machine learning models based on newly acquired data. This is because the server 130 is generally equipped with more powerful processors and greater memory capacity than local devices, such as cameras 112 and edge devices 110. The vehicle management server 130 can also act as central repository for data collected from multiple sources across multiple facilities. This centralized data management makes it more efficient to perform comprehensive analysis, run complex queries, and generate detailed reports that would be too resource-intensive for edge devices 110. The server 130 also provides the infrastructure to scale up operations without degrading performance. As the amount of data or the number of devices increases, servers can be upgraded or added to handle this increase more effectively than trying to upgrade many individual edge devices.

In some embodiments, the vehicle management server 130 receives images of the same vehicle captured by different cameras at different locations within the managed facility as the vehicle enters, navigates, and exits the facility. As described above, these images and sensing data are associated with events such as entry, exit, navigation, parking, or infractions. The vehicle management server 130 processes these events to determine whether they belong to the same vehicle. In response to determining that they do, the vehicle management server 130 associates the images and corresponding metadata with the same vehicle.

In some embodiments, the vehicle management server 130 processes the images associated with the same vehicle to generate an embedding that represents the vehicle, using a trained machine learning embedding model. The vehicle management server 130 can also perform a similarity analysis of the generated embedding against a database of embeddings created from previously captured vehicle images to identify a set of candidate matches. Each of the candidate matches may also be associated with metadata, and the vehicle management server 130 performs another similarity analysis, comparing the metadata of the vehicle against the metadata of each candidate match to identify the most similar vehicle in the set. The most similar vehicle in the set of candidate matches is then identified as the vehicle.

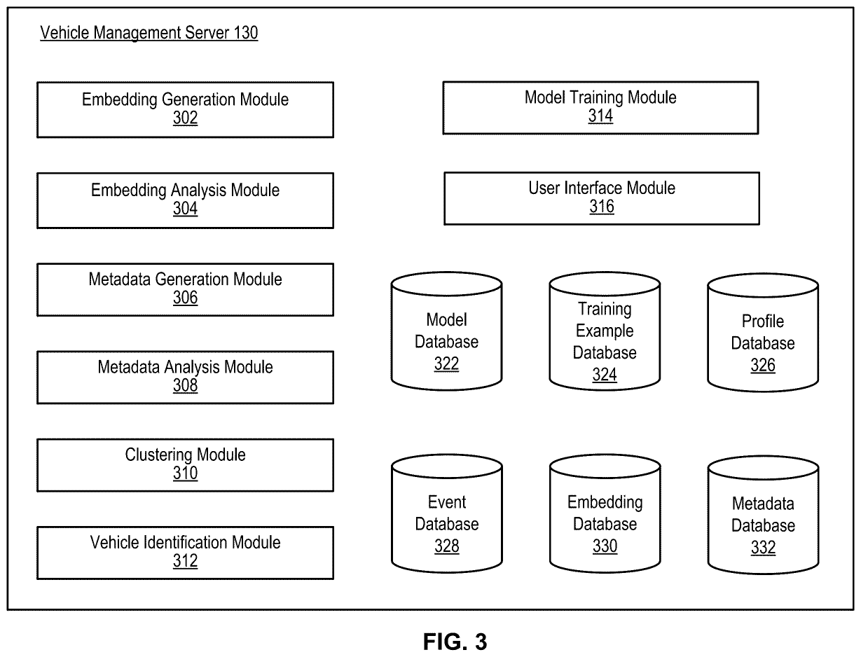

In some embodiments, the vehicle management server 130 can also provide a graphical user interface to users, such as drivers or facility managers. Additional details about the vehicle management server 130 are further described below with respect to FIG. 3.

Client devices 140 may be devices associated with drivers and/or facility managers, such as mobile devices, personal computers, among others. Client devices 140 may include a user agent (e.g., a browser or a mobile app), which allows a user to interact with the vehicle management server 130. For example, a driver may be able to see sessions associated with their vehicle via a driver mobile app. A facility manager may be able to see reports related to their managed facility, such as a total number of vehicles inside the facility and their identifiers via a management portal.

FIG. 2 illustrates an example architecture of an edge device 110, in accordance with one or more embodiments. The edge device 110 includes an event detection module 210, one or more machine learning models 220, a vehicle identification module 230, a metadata generation module 240, and a remediation action module 250. The modules listed in FIG. 2 are illustrative examples, and depending on the type of devices and the functions desired by the managed facility, additional or fewer modules may be implemented in an edge device 110. Modules within the edge device 110 can be configured flexibly: multiple modules may be combined into one to perform a range of functions, or a single module might be split into several, with each handling a specific subset of tasks. Some functions of these modules are performed by a combination of the edge device 110, the vehicle management server 130, and/or other devices.

The event detection module 210 is configure to detect various events. In some embodiments, the event detection module 210 includes multiple submodules. These submodules includes a speed detection module 211, an infraction detection module 212, an entry detection module 213, an exit detection module 214, an approaching event detection module 215, and an away event detection module 216. Notably, the submodules listed here are also illustrative examples, additional or fewer submodules may be implemented in an event detection module 210 of an edge device. For example, an edge device 110 coupled to a parking sensor may be a single function sensor configured to detect parking events. An edge device 110 coupled to a camera may be able to detect a variety of events, including infraction events.

The speed detection module 211 is configured to determine a speed of a vehicle within the managed facility. In some embodiments, the speed detection module 211 uses images captured by the cameras and/or sensing data generated by the sensors to determine the speed at which vehicles travel through different points within the facility. The direction detection module 212 is configured to detect a directional movement of vehicles, such as approaching a camera or sensor or away from the camera or sensor. In some embodiments, the direction of the vehicle may be determined by analyzing the sequence of images captured by the camera.

The entry detection module 213 is configured to monitor and detect when vehicles enter the facility. In some embodiments, the entry detection module 213 uses cameras or sensors placed at entry points to detect and register each vehicle as it enters the facility. Similarly, the exit detection module 214 is configured to monitor and detect when vehicles leave the facility. In some embodiments, the exit detection module 214 also uses cameras or sensors placed at exit points to detect and register each vehicle as it leaves the facility. Entry and exit events are special events because when an entry event is detected, a new session is generated. Subsequent events detected will be associated with this new session. Conversely, when an exit event is detected, the session is closed. Once the session is closed, no new events can be associated with the session. For instance, when a vehicle leaves the facility, its current session is closed, and in response to re-entering the facility, a new session is initiated for that vehicle.

The approaching event detection module 215 is configured to detect vehicles as they approach a camera or sensor within the managed facility. In some embodiments, when a vehicle approaches a sensor, it may trigger a motion detector, break a light beam, or be detected by other proximity sensors that activate the camera. The camera, once activated, captures images or video. Image recognition models analyze the frames to detect movement towards the sensor. The models can differentiate between approaching and receding movements based on the change in size and orientation of the vehicle image within the frame. As the vehicle approaches the camera or sensor, the vehicle size in the images increases, and the approaching event detection module 215 determines the movement direction approaching the camera or sensor.

The away event detection module 216 is configured to detect vehicles as they move away from the camera or sensor within the managed facility. Similar to the approach detection, away events can be triggered by the vehicle breaking a sensor connection, such as moving out of a light beam or reducing motion detected by motion sensors. The camera, once activated, captures the vehicle moving away, and image recognition models analyze the sequence of images. As the vehicle moves away, its image size decreases, and the models determine this movement direction away from the camera or sensor.

The infraction detection module 212 is configured to identify violations caused by vehicles or facility users. Infractions might include damage to the facility's gates (e.g., bumping into or crashing through them), damage to other vehicles, unauthorized entry, speeding, improper use of parking spaces, or unauthorized presence during restricted hours (e.g., overnight stays). Additionally, user-related infractions can include vandalism or theft of vehicles. The detection is based on various sensor data such as from cameras, gate sensors, parking sensors, audio sensors, or speedometers.

For instance, gate sensors can detect if a gate remains ajar, suggesting it may have been struck, while audio sensors might pick up the sound of breaking glass, indicating a break-in. The infraction detection module 212 uses different sensors to ascertain different types of infractions. If multiple parking sensors indicate that spaces are occupied concurrently, it might suggest a single vehicle occupying multiple spaces, which can then be verified using camera data.

Moreover, the infraction detection module 212 can employ a combination of sensors to enhance detection accuracy. For example, combining audio detection of a break-in with visual confirmation from cameras. It can also control moveable camera systems, such as drones or cameras on tracks, directing them to the infraction site to gather precise visual evidence and potentially follow moving subjects. In some embodiments, the infraction detection module 212 may also be configured to record all infractions in an infraction database with detailed metadata, including timestamps.

In some embodiments, images and/or sensing data of sessions associated with infractions are annotated with metadata describing the corresponding infraction. The images and/or sensing data can then be used as training data to train a machine learning model. The machine learning model is trained to receive a set of one or more images and/or sensing data associated with a vehicle in a session, and determine a likelihood that the vehicle has committed at least one of multiple infractions. In response to determining that the likelihood that the vehicle has committed an infraction is greater than a predetermined threshold, the infraction detection module 212 determines that an infraction has occurred. For example, the type of infractions that the machine learning model can detect may include (but are not limited to) speeding, parking violations, traffic flow violation (wrong-way driving), stop sign and traffic light violations, idle time excess, noise violations, tailgating, among others.

The remediation action module 250 is configured to initiate a predefined corrective action in response to detecting an infraction. These actions can be automated or may require human intervention, depending on the severity and nature of the infraction. For example, in some embodiments, the remediation action module 250 may issue fines or alerts, initiating physical barriers, or notifying facility management.

For instance, in response to detecting, by the infraction detection module 212, that a vehicle is speeding through the facility, the remediation action module 250 may retrieve the driver's identification from the system's database based on the vehicle identification. The remediation action module 250 can then automatically generate and send a push notification to the mobile app installed on the user's smartphone, alerting them to the infraction and advising them to reduce their speed.

Alternatively, or in addition, the remediation action module 250 may interact with the vehicle management server 130 to update vehicle profiles or modify access permissions based on the infractions.

Notably, whether it is an event, an infraction, or a remediation action, it is advantageous to associate the detected event, infraction, or remediation action with an identity of a vehicle to enable tracking. The vehicle identification module 230 is configured to perform vehicle identification. In some embodiments, the vehicle identification module 230 uses the one or more pretrained machine learning models 220 to perform vehicle identification.

Various machine learning models 220 may be trained to identify vehicles. In some embodiments, the one or more machine learning models 220 include a license plate identification model configured to identify the license plate of a vehicle.

In some embodiments, the one or more machine learning models 220 include an embedding model trained to process images associated with vehicles to generate embeddings of vehicles. These embeddings capture the characteristics of each vehicle, such as its shape, size, color, and unique visual markers (e.g., dents, stickers, or patterns), in a way that may be represented as a fixed-length vector regardless of the image size. Similar vehicles (e.g., two white sedans of similar size) will have embeddings that are close to each other in a vector space (also referred to as an “embedding space”).

The embedding of the vehicle is compared with embeddings of other vehicles that have previously entered the managed facility or are registered as authorized vehicles to identify one or more matches. In response to identifying a match, the identification of the matched vehicle may be deemed the identification of the vehicle.

In some embodiments, the output of the machine learning models 220 includes the identity of a matched vehicle and a confidence score. For example, the output of the license plate identification model includes the identity of a license plate and a confidence score. If the confidence score is greater than a threshold, the identified license plate is deemed the identification of the vehicle, and additional analysis is not required. On the other hand, if the confidence score is no greater than the threshold, the embedding model is applied.

As another example, the identified match based on the comparison of the embeddings may also be associated with a confidence score. If the confidence score is greater than a threshold, the identified vehicle is deemed the identification of the vehicle, and additional analysis is not required. On the other hand, if the confidence score is no greater than the threshold, additional metadata analysis is performed.

In some embodiments, license plate identification is performed after the embedding matching and/or metadata analysis. Only when the embedding matching and/or metadata analysis result in ambiguity, the license plate identification is then applied.

In some embodiments, license plate identification, embedding matching, and/or metadata analysis are performed in parallel or partially in parallel. The outputs of each of these identification processes are combined to determine the identification of the vehicle.

In some embodiments, license plate feature is one of the features encoded in the embedding. Thus, separate license plate identification is not required; embedding and/or metadata matching is used to identify vehicles.

In some embodiments, the vehicle identification module 230 may apply a first machine learning model to localize a vehicle in an image, and generate a bounding box around the location of the vehicle in the image. The vehicle identification module 230 may then apply the embedding model to a portion of the image within the bounding box associated with the vehicle. Responsive to receiving the portion of the image, the embedding model is trained to output an embedding (which is a numerical vector) that represents features of the vehicle. In some embodiments, the embedding of the vehicle is compared with embeddings of vehicles that have previously entered the managed facility or are registered as authorized vehicles of the managed facility. In some embodiments, the embeddings of vehicles are stored in a database local to the edge device 110. The vehicle identification module 230 performs the comparison between the embedding of the vehicle and the embeddings stored in the database to identify a set of matches.

Alternatively, the embedding of the vehicle may be transmitted to the vehicle management server 130, which has access to an embedding database storing embeddings of many vehicles. In response to receiving the embedding of the vehicle, the vehicle management server 130 may compare the embedding of the vehicle with embeddings stored in the database to identify a set of candidate matches.

Alternatively, or in addition, a subset of vehicle embeddings is stored in a database local to the edge device 110, while a full database is stored with the vehicle management server 130. The subset of vehicle embeddings may include recently entered vehicles, registered or authorized vehicles, frequent visitors, or vehicles flagged for monitoring, among others. In some embodiments, if no match is identified from the subset of vehicle embeddings, the vehicle identification module 230 transmits the embedding of the vehicle to the vehicle management server 130 to enable it to identify matches from the full database.

In some embodiments, the embedding of the vehicle is compared with embeddings of vehicles that are known to be within the managed facility at the time of comparison. For example, if the facility is equipped with a controlled entry/exit system, the comparison may be limited to vehicles with a recorded entry event that have not yet exited. If no match is found within this subset, the comparison may expand to include embeddings of other vehicles that have previously entered the managed facility or are registered as authorized vehicles. By first limiting the comparison to vehicles known to be present, computational efficiency can be improved while maintaining accuracy.

In some embodiments, the embeddings of vehicles known to be within the managed facility at the time of comparison are stored in a database local to the edge device 110, while the full database is stored with the vehicle management server 130. The vehicle identification module 230 first performs a comparison between the embedding of the vehicle and the embeddings in the local database. If no match is found within the local database, the vehicle management server 130 is caused to perform an expanded comparison in the full database.

In some embodiments, the similarity between the received embedding and each embedding in the database is determined using a distance metric, such as cosine similarity, Euclidean distance, or Manhattan distance. Cosine similarity measures the angle between two vectors, representing their directional similarity. Euclidean distance measures the straight-line distance between two vectors in the embedding space. Manhattan distance measures the sum of absolute differences along each dimension.

In some embodiments, the set of identified candidate matches includes embeddings of vehicles with a distance metric lower than a predetermined threshold or a top number of candidate matches with the lowest distance metrics. In some embodiments, if a candidate match has a distance metric to the embedding of the vehicle that is sufficiently low (lower or no greater than a threshold value), the candidate match is determined to be the match, and no additional analysis is required. Alternatively, embeddings are ranked based on their distance metrics, and a top number of embeddings with the lowest distance metrics, such as the top 100 closest embeddings in the embedding space, are identified as candidate matches, and additional analysis is performed on this set of candidate matches based on the metadata of the vehicle, as further described below.

In some embodiments, the vehicle identification module 230 may also receive metadata associated with images from the metadata generation module 240. Such metadata may be associated with events, such as entry, exit, navigation, speed, etc. Alternatively, or in addition, in some embodiments, the metadata generation module 240 may also use one or more machine learning models 220 to analyze images or sensor data captured within the managed facility to detect and identify features of vehicles, such as make, model, color, license plate layout or state. In response to identifying the features, the metadata generation module 240 may also record these features as metadata associated with the vehicles.

In some embodiments, each candidate match in the identified set is also associated with a set of metadata. The edge device 110 may transmit the metadata associated with the current vehicle to the vehicle management server 130, causing the vehicle management server 130 the candidate matches from the database, and compare metadata of the candidate matches with the metadata of a current vehicle to determine similarities. A most similar candidate match may be identified and transmitted from the vehicle management server 130 to the vehicle identification module 230, which in turn can cause the edge device 110 to perform various actions, e.g., opening a gate, or registering an event associated with the identified vehicle.

By comparing the metadata, the system can further differentiate between vehicles that might look visually similar, improving precision in vehicle identification. The metadata complements visual embeddings by adding contextual information, enabling more robust matching in scenarios where embeddings alone might not suffice.

For example, after a vehicle enters a managed facility, multiple cameras can capture images of the vehicle at different locations within the facility. The captured images may be processed by the vehicle identification module 230. The vehicle identification module 230 applies machine learning models to the captured images to generate an embedding representing the vehicle. This embedding can then be used to identify a set of candidate matches.

The vehicle identification module 230 may also collect metadata associated with vehicle events, such as timestamps, speed, movement direction, etc. Additionally, the vehicle identification module 230 may also apply machine learning models to identify the vehicle's color, make, model, and/license plate layout or state, e.g., blue TOYOTA CAMRY® with a California license plate. This information can also be recorded as metadata by the metadata generation module 240. The metadata can then be used to match the vehicle with a vehicle in the set of candidate matches.

The metadata associated with events, such as timestamps and movement direction can provide contextual information that complements image-based embeddings. For example, a candidate vehicle with a timestamp close to the observed vehicle's timestamp is more likely to be a match. Further, if the observed vehicle's movement direction indicates entry into the facility, the system may prioritize candidates whose last recorded event was leaving the facility, or whose previously recorded events include an entry at a similar time and location. On the other hand, if the observed vehicle's direction indicates it is leaving the facility, the system may prioritize candidates whose last recorded event was entering the facility.

The metadata associated with vehicles, such as color, model, make, license plate layout or state, can also provide contextual information that complements image-based embeddings. For example, vehicle identification module 230 may apply a machine learning model to the vehicle's captured image to determine its dominant color (e.g., red, blue, silver). During the matching process, the color metadata is compared with the recorded color of candidate vehicles in the database. If the observed vehicle is identified as “blue,” candidates with a matching color may be prioritized, while others may be excluded. Similarly, machine learning models may be trained and applied to determine the make and model of the vehicle (e.g., TOYOTA CAMRY®, TESLA MODEL 3®). This metadata can also be used as a differentiator in scenarios where vehicles of different types may look similar in embeddings. During identification, candidates with the same make and model may be prioritized for matching.

FIG. 3 illustrates an example architecture of the vehicle management server 130, in accordance with one or more embodiments. The vehicle management server 130 includes an embedding generation module 302, an embedding analysis module 304, a metadata generation module 306, a metadata analysis module 308, a clustering module 310, a vehicle identification module 312, a model training module 314, and a user interface module 316. The vehicle management server 130 also includes or has access to various databases, such as model database 322, training example database 324, profile database 326, event database 328, embedding database 330, and hanging event database 332.

The modules listed in FIG. 3 are illustrative examples, and depending on the type of devices and the functions desired by the managed facility, additional or fewer modules may be implemented in a vehicle management server 130. Modules within the vehicle management server 130 can be configured flexibly: multiple modules may be combined into one to perform a range of functions, or a single module might be split into several, with each handling a specific subset of tasks. Some functions of these modules are performed by a combination of the vehicle management server 130, the edge device 110, and/or other devices.

The embedding generation module 302 is configured to process images captured by cameras in a managed facility to generate embeddings that represent the visual features of vehicles. The embedding analysis module 304 is configured to compare the embedding of a vehicle to embeddings of other vehicles stored in the embedding database 330 to identify a set of candidate matches based on similarity metrics or distance metrics. The metadata generation module 306 is configured to process images and sensor data received from edge devices 110 in the managed facility to generate metadata, such as vehicle make, model, color, license plate details, speed, direction, and timestamps. The metadata analysis module 308 is configured to refine the set of candidate matches by comparing the metadata of the vehicle with metadata associated with embeddings of candidate matches. The vehicle clustering module 310 is configured to cluster embeddings stored in the embedding database 330 based on their spatial proximity in the embedding space. The vehicle identification module 312 is configured to coordinate the embedding analysis module 304, the metadata analysis module 308, and the vehicle clustering module 310 to perform analyses and use the outputs of these modules to determine the identification of the vehicle. Additional details of each of these modules are further described below.

The embedding generation module 302 is configured to receive an image of a vehicle captured by cameras within a managed facility and generate an embedding of the vehicle. In some embodiments, the embedding generation module 302 applies a first machine learning model to the image of the vehicle to localize the vehicle, i.e., identify the vehicle's position in the image, and generate a bounding box around it. The portion of the image within the bounding box is then passed to a second machine learning model, which is an embedding model, to generate an embedding of the vehicle. The embedding model is trained to encode an image of a vehicle (which may be of any size) into an embedding, which is a fixed-length numerical vector, regardless of the image size. The embedding generated by the embedding generation module 302 represents the vehicle in an embedding space, where similar vehicles (e.g., vehicles of the same size and shape) have embeddings that are close to each other, while distinctive vehicles have embeddings that are farther apart in the embedding space.

The embedding generation module 302 may store the generated embedding of the vehicle in the embedding database 330. The embedding database 330 is a central repository configured to store and manage embeddings of vehicles, and it stores many embeddings of vehicles that have entered and/or exited the managed facility, and/or registered as authorized vehicles within the managed facility.

The embedding analysis module 304 is configured to analyze the newly generated embedding of the vehicle against other embeddings stored in the embedding database 330. In some embodiments, the embedding analysis module 304 compares the newly generated embedding with embeddings stored in the embedding database 330 to identify potential matches. In some embodiments, the embedding analysis module 304 determines a similarity or distance between the new embedding and each stored embedding using a predetermined metrics, such as cosine similarity, Euclidean distance, and/or Manhattan distance. Based on the similarity metrics, the embedding analysis module 304 identifies a set of candidate matches. In some embodiments, these candidate matches are embeddings that fall within a predetermined distance threshold. Alternatively, or in addition, these candidate matches are a top number of embeddings with the smallest distance metrics from the new embedding. In some embodiments, these candidate matches are ranked by their proximity to the new embedding in the embedding space.

In some embodiments, in response to identifying a candidate match that is sufficiently close to the new embedding (i.e., a distance metric is lower than a predetermined threshold), the vehicle identification associated with the candidate match is deemed as the identification of the current vehicle. In some embodiments, in response to determining that no candidate matches meet the required threshold for similarity or distance, the metadata analysis module 308 further performs analysis on metadata associated with the vehicle against metadata of other vehicles in the database.

In some embodiments, the metadata analysis module 308 is applied as part of the identification process without requiring a decision based on the embedding similarity or license plate determination. In some embodiments, the system may always perform a metadata analysis step in parallel with or after the embedding comparison, regardless of whether a candidate match is identified.

The metadata generation module 306 is configured to process images and sensing data associated with vehicles received from the edge devices 110 to generate metadata. In some embodiments, the metadata generation module 306 applies one or more machine learning models to analyze the images and extract features, such as vehicle make, model, and color, license plate layout and/or state, unique characteristics like stickers, dents, or patterns. In some embodiments, the metadata generation module 306 may also processes data generated by sensors, such as vehicle speed, movement direction (e.g., entering, exiting, reversing), and timestamps for recorded events. The extracted features and contextual data are formatted and stored as metadata associated with the vehicle or its corresponding embedding.

For example, when a vehicle enters the managed facility, its image and movement data are captured by a camera and/or a sensor in the facility. The metadata generation module 306 receives the image and sensor data from an edge device 110 coupled to the camera and/or the sensor. The metadata generation module 306 processes the image to identify the vehicle's color, make, and model, e.g., a “red TOYOTA CAMRY®,” and processes the sensing data to determine that the vehicle's speed is 15 mph and its direction is entering at a particular time, e.g., Dec. 29, 2025, 12:05 PM. The information “red TOYOTA CAMRY®,” entering, 15 mph, timestamp: Dec. 29, 2025, 12:05 PM is stored as metadata associated with the vehicle in the metadata database 332. In some embodiments, the embedding database 330 and metadata database 332 can be joined by identifiers of vehicles, identifiers of events, and/or identifiers of registered drivers or users of managed facilities.

The metadata analysis module 308 is configured to analyze the metadata associated with the current vehicle against metadata associated with embeddings stored in the embedding database 330. As described above with respect to the embedding analysis module 304, in some embodiments, a set of candidate matches (e.g., top 100 closest embeddings in the embedding space, 100 being merely exemplary and any truncation point being applicable) may have been identified by comparing the embedding of the vehicle with embeddings stored in the embedding database 330. Each candidate match is associated with an embedding of a vehicle and metadata linked to that vehicle. The metadata analysis module 308 is configured to retrieve the metadata associated with each vehicle corresponding to a candidate match and compare the retrieved metadata with the metadata of the current vehicle. The metadata analysis module 308 prioritizes candidate matches that have metadata matching the metadata of the current vehicle.

Notably, search through an entire database of metadata can be computationally expensive, especially when dealing with tens of thousands of records. By narrowing the search to a manageable subset of top candidates (e.g., top 100), the system reduces the computational load required for subsequent analysis, including metadata comparison. Further, since the set of candidates are selected based on a high level of similarity in the embedding space, this ensures that only the most relevant vehicles' metadata is considered for further analysis. For time-sensitive applications, such as opening gates or managing vehicle flow, identifying the top candidates also enables quicker final decision-making.

Alternatively, the metadata analysis module 308 may be configured to identify a set of candidate matches that have matching metadata with the current vehicle. The embeddings of this set of candidate matches are then compared with the embedding of the current vehicle to identify the most similar vehicle.

In some embodiments, the metadata associated with events, such as timestamps and movement direction can provide contextual information that further complements image-based embeddings and vehicle metadata. For example, a candidate vehicle with a timestamp close to the observed vehicle's timestamp is more likely to be a match. Further, if the observed vehicle's movement direction indicates entry into the facility, the system may prioritize candidates whose last recorded event was leaving the facility, or whose previously recorded events include an entry at a similar time and location. Prioritizing certain candidates means that embeddings associated with those candidates are compared first to identify matches. Only if no match is found among the prioritized candidates are additional candidates considered. On the other hand, if the observed vehicle's direction indicates it is leaving the facility, the system may prioritize candidates whose last recorded event was entering the facility.

The vehicle clustering module 310 is configured to analyze embeddings stored in the embedding database 330 to identify clusters of embeddings that are close to each other. In some embodiments, the vehicle clustering module 310 analyzes the spatial relationship between embeddings in the embedding space, and clusters embeddings that are close to each other based on predefined threshold distance metrics. Methods used for clustering embeddings may include (but are not limited to) k-means clustering, density-based spatial clustering of applications with noise (DBSCAN), agglomerative hierarchical clustering, hierarchical density-based spatial clustering of applications with noise (HDBSCAN), Gaussian mixture models (GMM), spectral clustering, among others.

In some embodiments, embeddings that are clustered together are determined to correspond to the same identifier of a vehicle. In response to determining that an embedding of a current vehicle to be identified falls within one of the clusters, the vehicle identification module 312 may determine that the vehicle is associated with the identifier of the cluster.

The model training module 314 is configured to train and/or retrain various machine learning models using the training examples stored in the training example database 324. The trained and/or retrained machine learning models are stored in the model database 322. These models may include (but are not limited to) subsequent/precedent event prediction model (trained to predict a most likely subsequent event or precedent event based on a given event), vehicle localization models (trained to determine a position and orientation of a vehicle in an image), vehicle identification models (trained to identify an vehicle in an image), license plate localization models (trained to determine a position and orientation of a license plate in an image), license plate identification models (trained to identify a license plate), other feature identification models trained to identify other features of a vehicle (e.g., model, make, sticker), which may further be used to in combination of the vehicle identification models and/or license plate identification models to identify vehicles.

The training examples may include labeled and/or annotated images. For training a model associated with vehicle localizations and identifications, each image in the training examples may include a bounding box around each vehicle in the image, and the bounding box may further be annotated with an identification of the vehicle. For training a model associated with license plate localizations and identifications, each image in the training example may include a bounding box around each license plate in the image. These models may be trained using a variety of machine learning techniques, including (but not limited to) decision trees, random forests, gradient boosting machines (GBM), neural networks, Markov chains, recurrent neural network (RNNs), long short-term memory (LSTM) networks, convolutional neural networks (CNNs), YOLO (You Only Look Once), SSD (single shot multibox detector), region-based CNNs (R-CNNs), transfer learning, data augmentation techniques, ensemble learning, feature pyramid networks (FPN), semantic segmentation, and neural architecture search (NAS).

In some embodiments, the models may be trained and retrained based on correction data. The correction data is generated from instances where the initial model outputs were incorrect and subsequently corrected either through manual review by human operators or automatically corrected using hanging events and session matching. The correction data may include images with bounding boxes annotated with correct labels. In some embodiments, in response to detecting a vehicle or a license plate, the models generate a bounding box and annotate the bounding box with the identified feature (e.g., an identifier of a vehicle, an identifier of a license plate). However, if the correction data indicates such identification was incorrect, a new training example may be generated based on this image with corrected feature.

Additional details about the training and retraining of machine learning models can be found in U.S. Non-Provisional application Ser. No. 18/806,295, filed on Aug. 15, 2024, which is hereby incorporated by reference in its entirety.

The profile database 326 is configured store information about each vehicle that has entered or exited the managed facility. Such information includes the vehicle's make, model, color, license plate number, and potentially other identifying characteristics, such as stickers, wheel designs, among others. The profile database 326 can also store historical sessions of each vehicle. In some embodiments, the server 130 may also support user profiles, and the profile database 326 may also include owner or driver information linked to each vehicle.

The event database 328 is configured to store records of various events detected within the managed facility. This may include (but is not limited to) data on vehicle entries, exits, parking events, infractions, and any other sensor-triggered events. For example, each record may contain information such as a time and date of the vent, the location within the facility where it occurred, and specifics about the vehicle involved, like its license plate or vehicle identification.

### Example Embedding Space of Vehicles

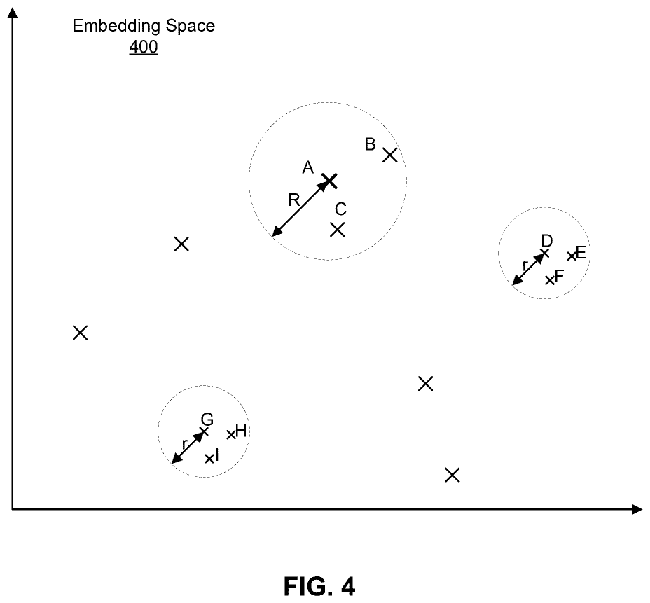

FIG. 4 illustrates an example embedding space 400 of vehicles, in accordance with one or more embodiments. Each point within the embedding space 400 corresponds to an embedding of a vehicle in an image. The spatial relationships between points in the embedding space 400 reflect the similarity between vehicles. For example, vehicles with similar features (e.g., size and shape) are represented by embeddings that are close to each other in the embedding space 400, while vehicles with distinct features are represented by embeddings that are farther apart.

For example, point A corresponds to an embedding of a current vehicle that is to be identified. The embedding analysis module 304 identifies embeddings corresponding to points B and C as a set of candidate matches because these embeddings are within a threshold distance R from the embedding corresponding to point A.

In some embodiments, the embeddings that have been identified to be associated with a same identifier of a vehicle are clustered together. These embeddings may have a distance metrics from each other within a predetermined threshold r. As illustrated, embeddings corresponding to points D, E, and F are within a predetermined threshold r, and are clustered together as corresponding to a same vehicle identification; and embeddings corresponding to points G, H, I are within a predetermined threshold r, and are clustered together as corresponding to a same vehicle identification. When a new embedding of a vehicle is generated and this new embedding falls within one of these clusters, the vehicle identification module 312 may identify the vehicle as the same vehicle associated with the cluster.

### Example Method for Tracking and Managing Vehicles in Managed Facilities

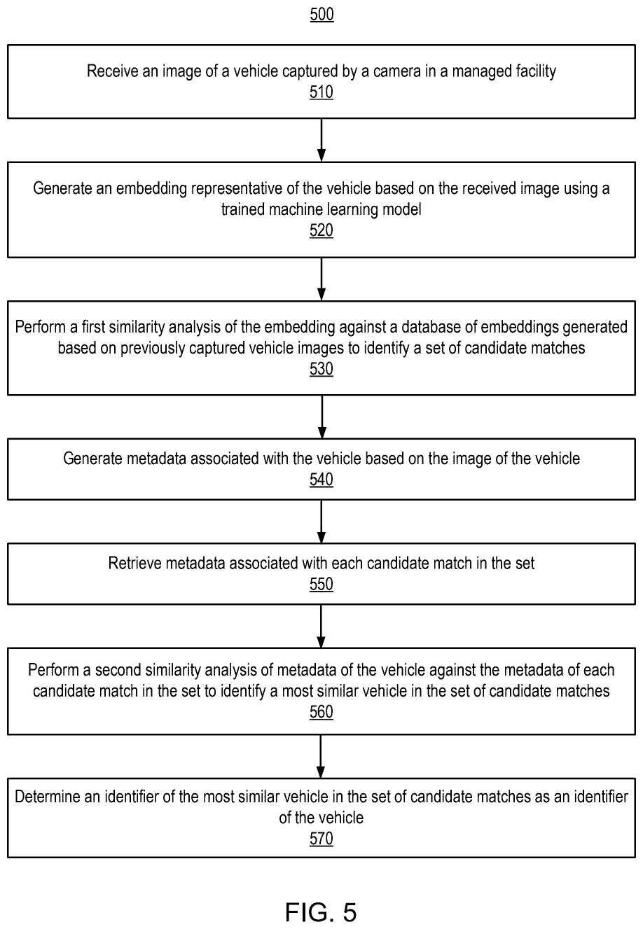

FIG. 5 is a flowchart of an example method for tracking vehicles in managed facilities, in accordance with one or more embodiments. Alternative embodiments may include more, fewer, or different steps from those illustrated in FIG. 5, and the steps may be performed in a different order from that illustrated in FIG. 5. Method 500 may be executed by one or more processors of a system, which may include an edge device 110, a vehicle management server 130, and/or a client device 140. The one or more processors may include processor of edge device 110 and/or of vehicle management server 130 executing instructions that cause one or more modules to perform their respective operations.

The system receives 510 an image of a vehicle captured by a camera in a managed facility. A managed facility refers to any environment or area where access and activity are monitored, controlled, or regulated, such as a multi-level parking garage, open parkin lots with gated entry/exit points, airports, highway toll collection systems, residential communities with gated entries, private housing complexes, corporate campuses, hospitals, logistics and distribution centers, university campuses, shopping centers and malls, car wash facilities, gated industrial zones, event venues, ports and harbors, government and military facilities, train or bus stations, taxi pickup/drop-off lanes, among others. There may be cameras and sensors installed within these managed facilities. The cameras are configured to capture images of vehicles that enters, navigates, and/or exits the facilities.

The system generates 520 an embedding representative of the vehicle based on the received image using a trained machine learning model. An embedding is a fixed-length numerical vector that encodes distinctive visual features of the vehicle captured in the image. The trained machine learning model may be a convolutional neural network (CNN) or another architecture configured to extract features from images and encode the features into embeddings. In some embodiments, the system applies a first machine learning model (also referred to a “localization model”) to the image to identify a location of the vehicle in the image and generates a bounding box around the vehicle. The system then applies a second machine learning model (also referred to an “embedding model”) to the portion of the image within the bounding box to generate the embedding. The embedding model is configured to process the portion of the image to extract and encode its features into the embedding, regardless of the image's resolution or size. The generated embedding exists in a multi-dimensional embedding space, where similar vehicles are represented by embeddings that are close to each other, and distinct vehicles are represented by embeddings that are farther apart.

The system performs 530 a first similarity analysis of the embedding against a database of embeddings generated based on previously captured vehicle images to identify a set of candidate matches. Each candidate match corresponds to an identifier of a vehicle. In some embodiments, the system maintains an embedding database (e.g., embedding database 330) that stores embeddings of vehicles captured during previous interactions with the managed facility. Each embedding in the database is associated with an identifier, which could include information like a vehicle ID or a user profile.

In some embodiments, the system compares the embedding with each embedding in the embedding database to determine a distance metrics that quantify similarity between the two embeddings in the embedding space. The distance metrics may be a cosine similarity (which measures an angle between two embeddings), a Euclidean distance (which measures a straight-line distance between two embeddings), and/or a Manhattan distance (which measures a sum of absolute differences along each dimension). The system may identify a set of candidate matches, which are embeddings from the database that are closest to the current vehicle's embedding in the embedding space. In some embodiments, each candidate is within a threshold distance from the embedding of the current vehicle. Alternatively, or in addition, a top N matches (e.g., the 5 closest embeddings) are selected.

The system generates 540 metadata associated with the vehicle based on the image of the vehicle. In some embodiments, the metadata may include (but is not limited to) make, model, color, and license plate layout or state of the vehicle. The metadata may also include (but is not limited to) unique visual features, such as stickers, dents, or patterns visible on the vehicle. In some embodiments, the system applies one or more pre-trained machine learning models to analyze the image of the vehicle to identify features of the vehicle, and stores these identified features as metadata of the vehicle. For example, the system may analyze the image of the vehicle and extract metadata, including make and model: TOYOTA CAMRY®, color: blue, license plate layout: California license plate. The generated metadata may be associated with the vehicle embedding and stored in the embedding database.

The system retrieves 550 metadata associated with each candidate match in the set of candidate matches, and performs 560 a second similarity analysis of metadata of the vehicle against the metadata of each candidate match in the set of candidate matches to identify a most similar vehicle in the set of candidate matches. In some embodiments, each candidate match in the embedding database has corresponding metadata that provides additional descriptive and contextual information about the vehicle, such as make and model, color, license plate layout or state, etc. The system compares the metadata of the current vehicle (e.g., make, model, color, license plate layout or state, etc.) with the metadata of each candidate match retrieved in step 550 to refine the candidate matches and identify the most similar vehicle. The comparison can prioritize candidate matches that align closely with the observed metadata.

The system determines 570 an identification of the most similar vehicle in the set of candidate matches as an identifier of the vehicle. In some embodiments, based on the second similarity analysis, the system identifies the vehicle in the candidate set whose metadata most closely matches the metadata of the current vehicle. This vehicle is then deemed the most similar vehicle, representing the likely identification of the current vehicle.

In some embodiments, performing a second similarity analysis includes assigning different weights to different metadata attributes based on their impacts on matching accuracy. For example, the license plate layout of a vehicle may have a higher weight than a sticker on the vehicle. If two candidate matches are considered—one with the same license plate layout but no matching sticker, and another with a different license plate layout but a matching sticker—the system may determine that the first candidate match with the same license plate layout is more similar to the current vehicle.

Notably, while the embedding-based analysis provides an initial set of candidate matches, the second similarity analysis uses metadata to further narrow down the matches, improving accuracy. Metadata comparison ensures that vehicles with similar embeddings but differing metadata (e.g., different license plate states) are not falsely identified as the same vehicle. In cases where embeddings alone are insufficient (e.g., visually similar vehicles), metadata provides additional distinguishing features to resolve ambiguities.

For example, referring back to FIG. 4, after embedding-based analysis associated with the current vehicle A, the system performs a first similarity analysis to identify a set of candidate matches (e.g., vehicles B and C) because the embeddings of B and C are both spatially close to point A in the embedding space. The system determines metadata for vehicle A as “white TESLA MODEL S®, California license plate.” The system then retrieves metadata for each candidate, B and C: vehicle B: “white TESLA MODEL S®, California license plate” and vehicle C: “white TESLA MODEL S®, Nevada license plate.” The system compares the metadata of vehicle A with the metadata of vehicles B and C to identify vehicle B as the most similar vehicle because vehicle B's license plate state is the same as that of vehicle A (California), whereas vehicle C's license plate state is Nevada, which differs from that of vehicle A.

In some embodiments, additional metadata associated with vehicle events may provide additional contextual information about vehicles'movements and interactions with the managed facility, which can also be used to narrow down vehicles in the embedding database. This metadata includes timestamps, indicating when specific events, such as entry, exit, or parking, occurred; movement direction, describing whether the vehicle is entering, exiting, or navigating within the facility; and speed data, capturing how fast the vehicle was moving during an event. These additional metadata can help further narrow down candidate vehicles by aligning the current vehicle's observed behavior with historical patterns stored in the database. For example, if the observed vehicle's direction is exiting, the system can focus on vehicles with recent entry events, ensuring logical consistency in identification.

In some embodiments, the system also determines whether a similarity score of the most similar vehicle (which may be generated via the first similarity analysis and/or the second similarity analysis) is greater than a threshold, responsive to determining that the similarity score of the most similar vehicle is no greater than the threshold, the system generates and displays an alert at a client device of facility management, triggering a manual review.

In some embodiments, embeddings in the embedding database are clustered based on their similarities within the multi-dimensional embedding space. These clusters may be formed using algorithms such as K-Means, DBSCAN, or Hierarchical Clustering, which analyze the spatial proximity of embeddings. The system may determine whether the embedding of the current vehicle falls within one of the clusters. In some embodiments, each cluster corresponds to a same identifier of a vehicle. In response to determining that the vehicle falls within one of the clusters, the system can assign the identifier of the cluster as the identifier of the vehicle. Alternatively, each cluster may be a type of similar looking vehicles, and in response to determining that the vehicle falls within one of the clusters, the system can then narrow down its analysis against vehicles within the cluster.

As such, clustering not only helps streamline the identification process by reducing the search space for new embeddings but also allows the system to handle slight variations in the same vehicle's representations caused by different angles, lighting conditions, or partial occlusions. For example, all observations of a vehicle with a same identifier may be captured at different times can be grouped into a single cluster. When a new vehicle embedding is generated, the system can quickly associate it with an existing cluster, if applicable, or create a new cluster for previously unseen vehicles. Clustering improves the efficiency and accuracy of the vehicle identification system, particularly in large-scale environments with extensive datasets.

### Example Managed Facility

FIGS. 6A-C depict embodiments of an exemplary managed facility and moveable gate. As depicted in FIG. 6A, a managed facility 600 includes a set of parking spaces 602 within which vehicles 605 (e.g., cars) may park. Managed facility 600 includes sensors, such as parking sensors 615 and cameras 112. Parking sensors 615 may be located within parking spaces 602 to detect when vehicles 605 are present. As depicted on the left-hand side of managed facility 600, managed facility 600 includes gates 114. The bottom gate 114 allows vehicles 605 to enter managed facility 600 from street 620 through an entry lane 640 and the top gate 114 allows vehicles 605 to exit managed facility 600 through an exit lane 635.

The gate sensor, parking sensors 615, and cameras 112 are configured to detect events and generating sensing data, including images captured by cameras 112. Metadata associated with timestamps of the events and locations of the sensor 615 or camera 112 are also stored with the sensing data and images and transmitted to the vehicle management server 130 via network 120.

Managed facility 600 may include a pedestrian door 610, allowing pedestrians to enter from, for example, a sidewalk 630. The pedestrian door may be locked and RFID enabled such that users may enter through the pedestrian door responsive to edge device 110 receiving, from the user, a set of user credentials. Example user credentials may include user personal information, contact information, account information, and vehicle information (e.g., make, model, color, license plate).

FIG. 6A also depicts an infracting vehicle 606. Edge device 110 may, through infraction detection module 212, determine that vehicle 606 is an infracting vehicle due to the way vehicle 606 is parked, where the vehicle is talking up two parking spots 602 instead of one parking spot 602. Responsive to detecting the infraction, edge device 110 may trigger a remediation action that allocates for the use of the multiple parking spaces. Responsive to detecting some infractions, edge device 110 may trigger remediation actions that deploy an exit blocking device (e.g., gate 114) that prevents movement of vehicle 605 (or 606) out from managed facility 600.

The cameras 112 are positioned at various locations within the management facility. Each camera 112 or other sensors coupled to the camera 112 may be able to detect a moving direction of a vehicle, e.g., approaching the camera 112 or away from the camera. Based on the moving direction of the vehicle, the system may detect different events, such as an approaching event and an away event.

FIGS. 6B and 6C depict embodiments of managed facility 600 in which a two-gate system is implemented in entry lane 640. The two-gate system includes a first gate 16 with cameras 112 pointed towards it and a second gate 115. Between the first gate 16 and the second gate 115 is a secondary zone 645. The secondary zone 645 includes access to the exit lane 635 (e.g., via crossing the dashed line). FIG. 6B shows operation of the two-gate system responsive to a non-infracting vehicle (e.g., vehicle 605) attempting to enter the managed facility. In FIG. 6B, responsive to detecting vehicle 605 at the first gate 16, edge device 110 may open the first gate 16, allowing vehicle 605 to pass into a secondary zone 645. While in the secondary zone 645, cameras 112 may take images of vehicle 605. Responsive to determining that vehicle 605 is not an infracting vehicle, edge device 110 may open the second gate 115, allowing vehicle 605 to enter managed facility 600. FIG. 6C shows operation of the two-gate system responsive to an infracting vehicle (e.g., vehicle 606) attempting to enter the managed facility. In FIG. 6C, responsive to detecting infracting vehicle 606 at the first gate 16, edge device 110 may open the first gate 16, allowing infracting vehicle 606 to pass into a secondary zone 645. While in the secondary zone 645, cameras 112 may take images of infracting vehicle 606. Responsive to determining that vehicle 606 is an infracting vehicle, instead of opening the second gate 115 as edge device 110 did for vehicle 605, edge device 110 may trigger a remediation action. For example, as a remediation action, edge device 110 may provide, for display at the second gate 115, a message to a user of infracting vehicle 606 asking the user to route infracting vehicle 606 into exit lane 635.

The aforementioned managed facility could be a parking facility that tags both entry and exit events for vehicles. However, different types of managed facilities might record a single tagged event or multiple tagged events per vehicle. For instance, a carwash facility might only tag a vehicle's entry into the wash area. Conversely, a drive-through restaurant could tag multiple events: one when a driver of the vehicle stops at a location for placing an order and another when the ordered items are handed over to the vehicle, completing the transaction. Additionally, an automated toll might tag just an entry or both an entry and exit event. In facilities that track multiple tagged events, vehicle misidentifications might be identified through unresolved (“hanging”) events. In contrast, facilities that record a single tagged event might detect misidentifications by comparing features between captured images of vehicles and registered vehicles within the system. Responsive to determining a misidentification of a vehicle, corrections can be made either manually or automatically, in a manner similar to that described above. For single tagged event scenarios, the correction data may be obtained without reference to another event. This correction data can also be used to generate additional training examples for retraining the machine-learning model for vehicle identification, continuously enhancing the accuracy of the machine-learning model through human-in-the-loop driven or automated retraining.

### Example Computer System

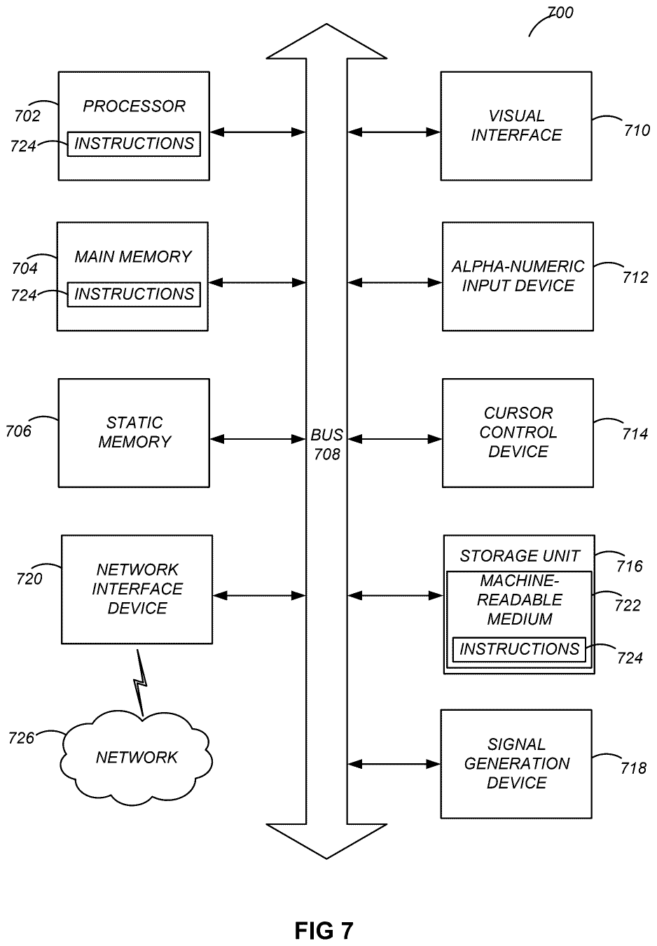

FIG. 7 is a block diagram illustrating components of an example machine able to read instructions from a machine-readable medium and execute them in a processor (or controller). FIG. (Figure) 7 is a block diagram illustrating components of an example machine able to read instructions from a machine-readable medium and execute them in a processor (or controller). Specifically, FIG. 7 shows a diagrammatic representation of a machine in the example form of a computer system 700 within which program code (e.g., software) for causing the machine to perform any one or more of the methodologies discussed herein may be executed. The program code may be comprised of instructions 724 executable by one or more processors 702. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 724 (sequential or otherwise) that specify actions to be taken by that machine. Further, while only a single machine is illustrated, the term “machine” shall also be taken to include any collection of machines that individually or jointly execute instructions 724 to perform any one or more of the methodologies discussed herein.

The example computer system 700 includes one or more processors 702 (e.g., a central processing unit (CPU), a graphics processing unit (GPU), a digital signal processor (DSP), one or more application specific integrated circuits (ASICs), one or more radio-frequency integrated circuits (RFICs), field programmable gate arrays (FPGAs)), a main memory 704, and a static memory 706, which are configured to communicate with each other via a bus 708. The computer system 700 may further include visual display interface 710. The visual interface may include a software driver that enables (or provide) user interfaces to render on a screen either directly or indirectly. The visual interface 710 may interface with a touch enabled screen. The computer system 700 may also include input devices 712 (e.g., a keyboard a mouse), a cursor control device 714, a storage unit 716, a signal generation device 718 (e.g., a microphone and/or speaker), and a network interface device 720, which also are configured to communicate via the bus 708.

The storage unit 716 includes a machine-readable medium 722 (e.g., magnetic disk or solid-state memory) on which is stored instructions 724 (e.g., software) embodying any one or more of the methodologies or functions described herein. The instructions 724 (e.g., software) may also reside, completely or at least partially, within the main memory 704 or within the processor 702 (e.g., within a processor's cache memory) during execution.

### Additional Configuration Considerations

The embodiments described herein improve the accuracy and efficiency of vehicle identification systems in managed facilities. Unlike traditional systems that rely heavily on license plate recognition, the embodiments described herein use machine learning-generated embeddings to capture comprehensive visual features of vehicles. Additionally, the incorporation of metadata, such as color, make, model, and license plate layout or state, enhances the precision of vehicle identification by adding contextual data to complement visual analysis. Furthermore, clustering embeddings allows the system to reduce computational complexity by narrowing the search space, making it scalable for large facilities with extensive vehicle records.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for seamless entry and exit to a managed facility blocked by a moveable gate through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method, comprising:
receiving an image of a vehicle captured by a camera in a managed facility;
generating an embedding representative of the vehicle based on the received image using a trained machine learning model;
performing a first similarity analysis of the embedding against a database of embeddings generated based on previously captured vehicle images to identify a set of candidate matches, each of which corresponds to an identifier of a vehicle;
generating metadata associated with the vehicle based on the image of the vehicle;
retrieving metadata associated with the set of the candidate matches;
for each candidate match in the set of the candidate matches, performing a second similarity analysis of the generated metadata against the metadata of the candidate match to identify a most similar vehicle in the set of candidate matches; and
determining an identifier of the most similar vehicle in the set of candidate matches as an identifier of the vehicle.

2. The method of claim 1, wherein generating metadata associated with the vehicle based on the image of the vehicle comprises:
applying one or more additional trained machine learning models to the image of the vehicle to identify attributes of the vehicles; and
storing the identified attributes of the vehicle as metadata of the vehicle, the metadata including one or more of a vehicle make, a vehicle model, and a license plate layout.

3. The method of claim 1, wherein an embedding representative of each vehicle is generated by:
applying a first machine-learning model to an image of the vehicle to identify a position of the vehicle in the image;
generating a bounding box surrounding the vehicle in the image;
applying a second machine learning model to a portion of the image in the bounding box to generate the embedding of the vehicle.

4. The method of claim 1, wherein the first similarity analysis or the second similarity analysis uses a distance metric defined by cosine similarity, Euclidean distance, or Manhattan distance.

5. The method of claim 4, wherein identifying the set of candidate matches includes
ranking embeddings in the database based on their distance metrics from the embedding; of the vehicle; and
selecting a predetermined number of ranked embeddings that have lowest distance metrics.

6. The method of claim 1, wherein performing a second similarity analysis includes assigning a higher weight for specific metadata attributes identified as having a higher impact on matching accuracy.

7. The method of claim 1, further comprising clustering embeddings in the database into clusters based on spatial proximity in an embedding space, wherein performing the first similarity analysis of the embedding against a database of embeddings includes determining whether the embedding of the vehicle falls within one of the clusters based on spatial proximity in the embedding space.

8. The method of claim 1, further comprising:
determining whether a similarity score of the most similar vehicle determined via the first similarity analysis or the second similarity analysis is greater than a threshold; and
responsive to determining that the similarity score of the most similar vehicle is no greater than the threshold, generating and displaying an alert at a client device of facility management, triggering a manual review.

9. The method of claim 1, further comprising:
receiving a plurality of images of the vehicle captured by a plurality of cameras located at different locations within the managed facility; and
generating the embedding based on the plurality of images.

10. The method of claim 1, further comprising:
analyzing event metadata associated with the vehicle against event metadata associated with each candidate match in the set of candidate matches, the event metadata including a timestamp of when an event associated with the vehicle occurred in the managed facility.

11. A non-transitory computer-readable medium comprising memory with instructions encoded thereon, the instructions comprising instructions to cause one or more processors to perform steps comprising:
receiving an image of a vehicle captured by a camera in a managed facility;
generating an embedding representative of the vehicle based on the received image using a trained machine learning model;
performing a first similarity analysis of the embedding against a database of embeddings generated based on previously captured vehicle images to identify a set of candidate matches, each of which corresponds to an identifier of a vehicle;
generating metadata associated with the vehicle based on the image of the vehicle;
retrieving metadata associated with the set of the candidate matches;
for each candidate match in the set of the candidate matches, performing a second similarity analysis of generated metadata against the metadata of the candidate match to identify a most similar vehicle in the set of candidate matches; and
determining an identifier of the most similar vehicle in the set of candidate matches as an identifier of the vehicle.

12. The non-transitory computer-readable medium of claim 11, wherein generating metadata associated with the vehicle based on the image of the vehicle comprises:
applying one or more additional trained machine learning models to the image of the vehicle to identify attributes of the vehicles; and
storing the identified attributes of the vehicle as metadata of the vehicle, the metadata including one or more of a vehicle make, a vehicle model, or a license plate layout.

13. The non-transitory computer-readable medium of claim 11, wherein an embedding representative of each vehicle is generated by:
applying a first machine-learning model to an image of the vehicle to identify a position of the vehicle in the image;
generating a bounding box surrounding the vehicle in the image;
applying a second machine learning model to a portion of the image in the bounding box to generate the embedding of the vehicle.

14. The non-transitory computer-readable medium of claim 11, wherein the first similarity analysis or the second similarity analysis uses a distance metric defined by cosine similarity, Euclidean distance, or Manhattan distance.

15. The non-transitory computer-readable medium of claim 14, wherein identifying the set of candidate matches includes
ranking embeddings in the database based on their distance metrics from the embedding; of the vehicle; and
selecting a predetermined number of ranked embeddings that have lowest distance metrics.

16. The non-transitory computer-readable medium of claim 11, wherein performing a second similarity analysis includes assigning a higher weight for specific metadata attributes identified as having a higher impact on matching accuracy.

17. The non-transitory computer-readable medium of claim 11, the steps further comprising clustering embeddings in the database into clusters based on spatial proximity in an embedding space, wherein performing the first similarity analysis of the embedding against a database of embeddings includes determining whether the embedding of the vehicle falls within one of the clusters based on spatial proximity in the embedding space.

18. The non-transitory computer-readable medium of claim 11, further comprising:
determining whether a similarity score of the most similar vehicle determined via the first similarity analysis or the second similarity analysis is greater than a threshold; and
responsive to determining that the similarity score of the most similar vehicle is no greater than the threshold, generating and displaying an alert at a client device of facility management, triggering a manual review.

19. The non-transitory computer-readable medium of claim 11, further comprising:
receiving a plurality of images of the vehicle captured by a plurality of cameras located at different locations within the managed facility; and
generating the embedding based on the plurality of images.

20. A system comprising:
memory with instructions encoded thereon; and
one or more processors that, when executing the instructions, are caused to perform operations comprising:
receiving an image of a vehicle captured by a camera in a managed facility;
generating an embedding representative of the vehicle based on the received image using a trained machine learning model;
performing a first similarity analysis of the embedding against a database of embeddings generated based on previously captured vehicle images to identify a set of candidate matches, each of which corresponds to an identifier of a vehicle;
generating metadata associated with the vehicle based on the image of the vehicle;
retrieving metadata associated with the set of the candidate matches;
for each candidate match in the set of the candidate matches, performing a second similarity analysis of generated metadata against the metadata of the candidate match to identify a most similar vehicle in the set of candidate matches; and
determining an identifier of the most similar vehicle in the set of candidate matches as an identifier of the vehicle.
